(19) United States
(12) Patent Application Publication
(10) Pub. No.: US 2007/0056685 A1
(43) Pub. Date: Mar. 15, 2007

(54) Method to position a frame

(75) Inventor: Philipp Prochaska, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,826

(22) PCT Filed: Sep. 14, 2004
(86) PCT No.: PCT/IB04/51754

§ 371 Date: Mar. 15, 2006

(30) Foreign Application Priority Data
Sep. 18, 2003 (EP) 03 103 444.0

(51) Int. Cl. B32B 37/00

(52) U.S. Cl. 156/272.8; 156/308.2; 353/120

(57) ABSTRACT

In a method of positioning and fixing at least one element relative to or on a frame, in particular a display (9, 10, 11), having a mount (R), of a projection device (1) on a frame (16) for another optically active element (14) of the projection device (1) that is arranged on the frame (16), wherein the element or the mount (R) of the display (9, 10, 11) and the frame (16) are formed on plastic sections that are to be connected to one another, it is provided that, following positioning and adjustment of the element, in particular of the display (9, 10, 11) relative to the frame (16), the element, in particular display, is connected to the frame by laser plastic welding, in particular point laser plastic welding.

The invention relates to a method of positioning and fixing at least one element relative to or on a frame, in particular a display, having a mount, of a projection device on a frame for another optically active element of the projection device that is arranged on the frame.

The invention also relates to a projection device for projecting image information, comprising at least one display which is to be positioned relative to a frame of another optically active element of the projection device and fixed to said frame.

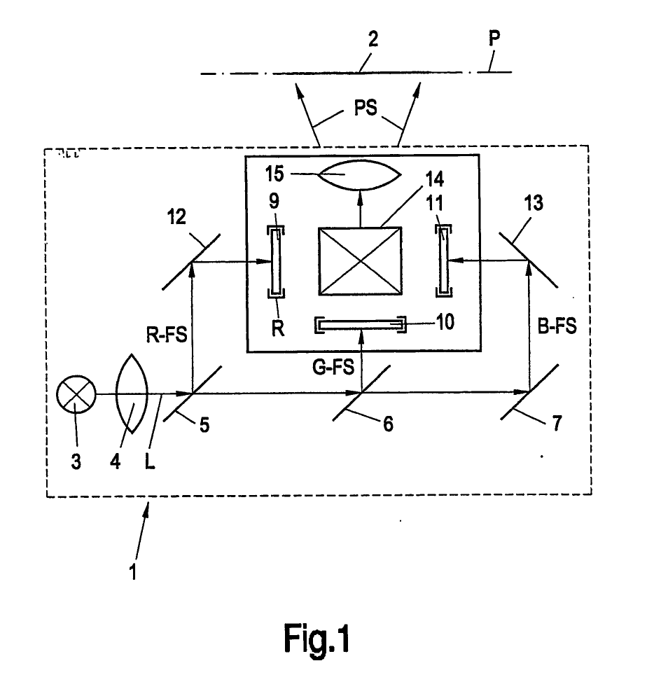

Such a method of positioning and fixing at least one element relative to or on a frame and such a projection device are known for example from US 2001/003368 A1. Said document discloses in general a method and a device for positioning a frame relative to a support, wherein this is used in particular on a projection device or projection unit, the design of such a projection device being shown in principle in FIG. 1. White light is split by two color splitters into a red color beam, a green color beam and a blue color beam. The three color beams each illuminate one display, wherein the respective color component of the overall image is shown by the respective display. In a recombination prism, the three color beams are combined to form a projection beam which is projected into a projection plane by device optics. In order to be able to obtain and/or project a sharp image into the projection plane by means of such a projection device, it is particularly important that the three displays are very precisely positioned in terms of their position with respect to one another and also to the prism and the device optics. Following appropriate positioning and adjustment of the elements or displays relative to the frame, in the known prior art according to US 2001/00333368 A1 the individual parts are fixed to one another by using an adhesive between the elements that are to be connected to one another, wherein the adhesive is cured for example by exposing it to UV light. Such adhesives that cure with or in UV light have been known for a long time. One disadvantage of such fixing is that not only is increased complexity of operation required to apply the adhesive between the individual parts that are to be connected to one another, but also correspondingly more time is required to reliably cure the adhesive. Moreover, upon curing, the adhesive exhibits uncontrollable shrinkage, which on account of the accuracy that can be achieved upon setting or adjusting the relative position of the individual elements with respect to one another cannot ensure precise, optically simple and permanent connection, so that a relatively high proportion of elements or displays that have been incorrectly fixed to the frame has to be expected following curing of the adhesive.

It is an object of the invention to provide a method and a projection device of the type mentioned in the introduction, in which the abovementioned disadvantages are avoided. In particular, the aim is for a more reliable and simpler connection, achievable in a shorter period of time, between the elements, in particular the display and the frame. In order to achieve the abovementioned objects, a method of positioning and fixing at least one element relative to or on a frame, in particular a display, having a mount, of a projection device on a frame for another optically active element of the projection device that is arranged on the frame, wherein the element or the mount of the display and mount parts of the frame are formed on plastic sections that are to be connected to one another, essentially comprises the following steps:
positioning the element, in particular the display, relative to the frame;
adjusting the element relative to the frame;
connecting the element to the frame by using laser plastic welding, in particular point laser plastic welding.

In order to achieve the abovementioned objects, in a projection device for projecting image information, comprising at least one display which is to be positioned relative to a frame of another optically active element of the projection device and fixed to said frame, it is essentially provided that at least one mount of the display and the mount parts of the frame are formed of plastic at regions that are to be connected to one another, wherein the mount of the display is fixed to the frame in its position relative to the frame by weld spots or a weld seam which are/is produced by laser plastic welding.

By means of the features according to the invention, the situation is achieved whereby following positioning of the element, in particular of the display relative to the frame, and adjustment, connection between the element or display and the frame can be achieved in a simple and reliable manner by using laser plastic welding, in particular point laser plastic welding. Compared to fixing or connection using an adhesive that can cure under UV light, the time required to fix the elements that are to be connected to one another is greatly reduced with the use according to the invention of a laser, and the time taken to apply the adhesive can be avoided entirely. It is furthermore assumed that the fixing or connection between the element or display and the frame takes place in a contactless and vibrationless manner, and furthermore that no particles or foreign material is released which could soil the elements of the projection device according to the invention, which elements must usually be joined together in a highly pure atmosphere. It is assumed that, compared to other thermal methods, by virtue of laser plastic welding, in particular when forming weld spots, a zone of the elements that are to be connected to one another which is affected by heat during the connection operation is small in comparison to other thermal methods, so that virtually no warping of the elements that are to be connected to one another is to be expected.

In relation to the connection of elements that are to be connected to one another and consist at least partially of plastic, laser plastic welding is known per se, as can be seen for example in U.S. Pat. No. 6,390,628 B1. In this known prior art, however, housing parts produced so that they fit precisely with one another are connected by laser plastic welding, so that it is assumed that the elements that are to be connected to one another bear flush or flat against one another in the region of the connections that are to be made.

By contrast, within the context of the method according to the invention and the projection device according to the invention, during positioning of the element, in particular the display, relative to the frame and adjustment between the element or mount of the display and the frame, in order to achieve the abovementioned relative positioning between the displays and the recombination prism and the device optics, clearances or spacings may be produced between the elements that are to be connected to one another, which clearances or spacings are filled with adhesive when a UV-curable adhesive is used. In the case of the laser plastic welding proposed according to the invention, such spacings or clearances are not bridged over or connected.

As claimed in the measures of claims 2 and 6 the advantage is obtained that by providing the jutting out, in particular elastically movable intermediate elements at least in the region of the weld spots that are to be formed, there is a bearing connection between the element or mount of the display and the frame via the intermediate elements, so that regions or surfaces that bear against one another and are to be connected to one another are available for subsequent connection by means of laser plastic welding.

As claimed in the measures of claim 3, this reliable bearing is achieved at least in the region of the weld spots that are to be produced by the laser plastic welding.

As claimed in the measures of claims 4 and 10, it is ensured that during the laser plastic welding the laser beam that strikes the element or the mount of the display from outside penetrates through the element or mount, and in that the heat of fusion necessary for reliable connection is produced on account of the increased absorption capability of the plastic of the frame and of the intermediate elements.

As claimed in the measures of claim 7, as a supplement to the measures of claim 6, the advantage is obtained that a reliable connection between the element or display and the frame can be achieved by intermediate elements that are simple to produce, wherein the arrangement of the intermediate elements also does not restrict the space needed for the light beams or respective color component to pass through.

As claimed in the measures of claim 8, the advantage is obtained that a reliable fixing can be carried out via the intermediate elements, which are clamped on one side and jut out, simply by providing weld spots in the region of the bearing connection between the intermediate element and the mount of the display.

As claimed in the measures of claim 9, the advantage is obtained that a sufficient laser energy to form the fusion and connecting zone can be introduced into the region of the mount of the frame, said mount having an increased absorption capability.

The invention will be further described with reference to examples of embodiments shown in the drawings to which, however, the invention is not restricted.

FIG. 1 shows, in a general manner, the beam path of light beams through optically active elements of a projection device for projecting image information.

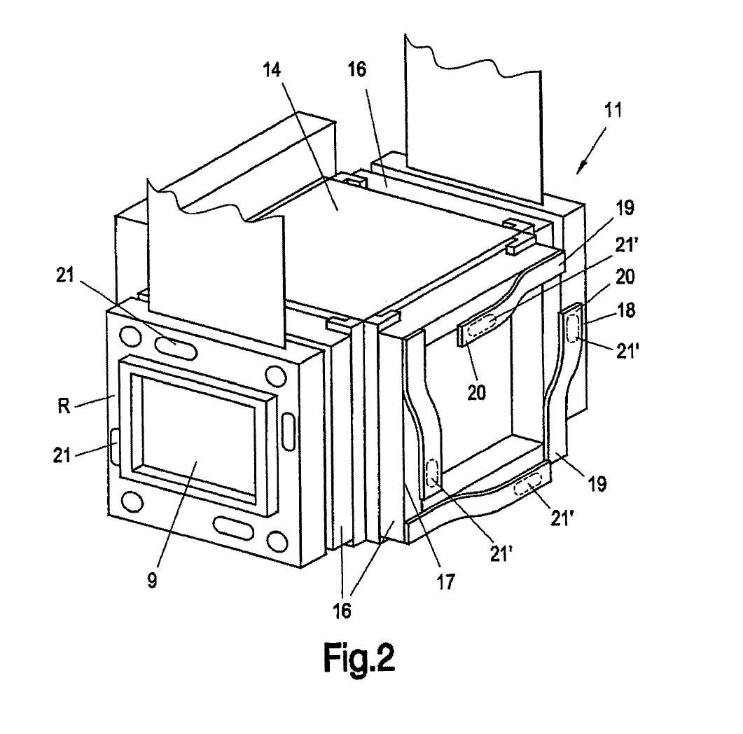

FIG. 2 shows a schematic perspective view of a projection device, wherein in the case of one display only the frame is shown.

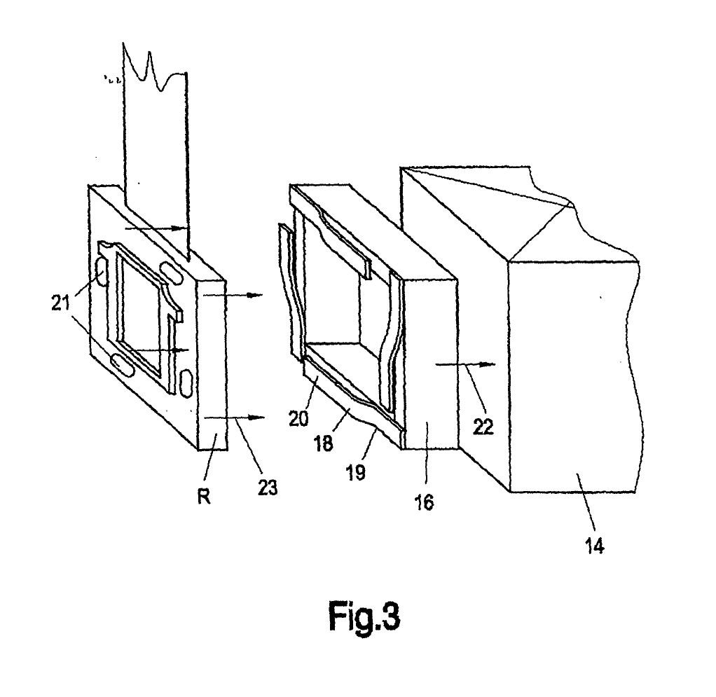

FIG. 3 shows a perspective, partially exploded view of the projection device of FIG. 2.

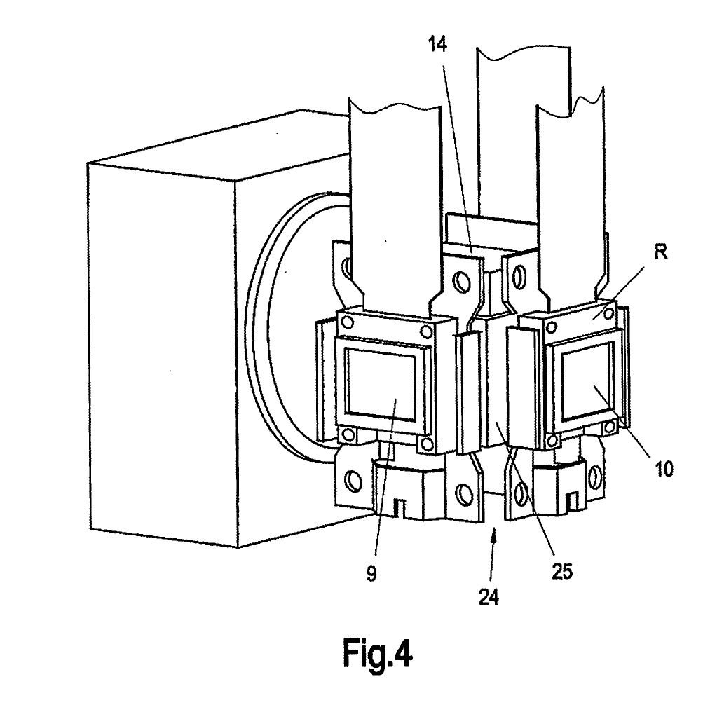

FIG. 4 shows a perspective, schematic diagram of a modified embodiment of a projection device.

FIG. 1 shows the beam path of light beams through optically active elements of a projection device 1 for projecting image information onto a projection screen 2 provided in a projection plane P. The projection device 1 comprises, for example, a mercury vapor lamp 3 from which white light L is output to convergence optics 4 during operation. A first color splitter 5 is reflective for red light and emits a red color beam R-FS, whereas the remaining color component of the white light L strikes a second color splitter 6. The second color splitter 6 is reflective for green light and emits a green color beam G-FS, whereas the remaining blue color component of the white light L is deflected by a first mirror 7 as a blue color beam B-FS.

The individual color beams R-FS, G-FS and B-FS are fed to displays 9, 10 and 11, with an additional deflection mirror 12 and 13 being shown for the red color beam R-FS and the blue color beam B-FS. The displays 9, 10 and 11 are in each case controlled such that depending on the transparency of the displays 9, 10 and 11 the respective color beam R-FS, G-FS and B-FS illuminates the individual displays so that the reaction of the respective color beam that represents the respective image information for projecting the image is incident on corresponding reflection surfaces of a recombination prism which bears the reference 14.

In addition, device optics bear the reference 15, said device optics outputting onto the projection plane P the projection beam PS recombined from the three color beams in the recombination prism 14.

Each display 9, 10 and 11 is in each case held in a mount element R which will be explained in more detail in the following figures. In order to obtain clear and sharp images on the projection plane P or the projection screen 2, there is a need for precise positioning of the displays 9, 10 and 11 relative to the recombination prism 13 and the device optics 15, a first embodiment for fixing and connection between the individual displays 9, 10 and 11 or the mounts R thereof and a frame being shown in detail in FIGS. 2 and 3, the frame being fitted on the recombination prism 14 or serving to carry the recombination prism.

In the diagram shown in FIG. 2, the recombination prism once again bears the reference 14, wherein, in accordance with the three boundary surfaces for fixing the displays 9, 10 and 11, frames that each bear the reference 16 are fixed directly on the outer surfaces of the recombination prism 14. Each frame 16 has, on the boundary surfaces facing the displays, intermediate elements 18 that run essentially parallel to the outer edges 17, which intermediate elements in each case are fixed at one side in a corner region 19 of the essentially square frame 16 and jut out. In the diagram shown in FIG. 2, the two displays 9 and 11 are fixed on the frame 16 in each case via their mount R, whereas the display 10 is not shown in any greater detail.

For the fixing of the mounts R of the displays 9, 10 and 11 and the relative positioning and adjustment in relation to the frames 16 and the recombination prism 14, the mounts R are brought into bearing connection with the intermediate elements 18 and in particular the free ends 20 thereof. Once correct relative positioning of the displays with respect to one another and to the recombination prism 14 has been achieved by a positioning device that is known per se and is not shown in any greater detail, the mounts R and thus the displays are then fixed to the frames 16 by laser plastic welding in regions or sections, in particular depressions or recesses 21, which are shown for the display 9 in FIG. 2. In the region of these depressions or recesses, the mount R, which is made of plastic, has for example a cross section that is smaller than the rest of the cross section of the mount R, so that a reliable connection between the mount R of the individual displays 9, 10 and 11 and the frame 16 with the interconnection of the intermediate elements 18 takes place even with correspondingly low-energy laser beams. The region of laser plastic welding to the intermediate elements 18 is shown in dashed line in FIG. 2 by the reference 21′. By providing at least one weld seam or weld spot in the region of the sections 21 and 21′, the mount R and hence the displays 9 and 11 are reliably and solidly fixed to the frames 16 and thus relative to the recombination prism 14 and the device optics that are connected downstream.

FIG. 2 shows a correspondingly large spacing between the mount R and the frame 16 in respect of the display 9 shown on the left-hand side, in particular in the right, top region, wherein this clearance or spacing can be reliably bridged over by providing the intermediate elements 18 and a direct bearing on the facing surface of the mount R for the laser plastic welding that is to be carried out can be achieved via the free ends 20 of the intermediate elements 18.

In the exploded diagram of FIG. 3, only one frame 16 and one mount R for a display is shown. It can be seen that the frame 16 can once again be fixed directly to the recombination prism 14 as shown by arrow 22. Furthermore, the elastically deformable intermediate elements 18 that are clamped at one side and jut out are provided, which intermediate elements, during positioning or adjustment of the mount R in the direction of the arrows 23 on the frame 16, in each case via the free ends 20 bring about a reliable bearing on the boundary surface of the mount R that faces the frame 16. In the diagram of FIG. 3, too, regions 21 on the outer side of the mount R are once again shown with a cross section that is smaller than the rest of the cross section.

In the embodiment shown in FIG. 4, it can be seen that an additional mount construction 24 is provided both to hold the recombination prism 14 and also to provide frames, bearing the reference 25, for the displays 9, 10 and 11 and mounts R thereof. In a manner similar to that of the previous embodiment shown in FIGS. 2 and 3, in the embodiment shown in FIG. 4 there is also a fixing of the displays 9, 10 and 11 via their mounts R to the frames 25 by laser plastic welding, wherein for example intermediate elements 18 are once again provided between the frames 25 and the individual mounts R of the displays, in order to ensure for the laser plastic welding a direct bearing between the elements that are to be connected to one another.

Besides the provision of depressed or recessed regions 21 of the mounts R of the individual displays, for correct connection and welding between the mounts R and the frames 16 or 25 or the interconnected intermediate elements 18 it is moreover provided that the mounts R are formed of a transparent plastic or that the plastic which forms the mounts R at least in the region of the fixing points 21 and 21′ has a lower absorption capability compared to the plastic of the frames 16 and 25 or of the intermediate elements 18, in order when using laser plastic welding to allow a reliable zone of fusion in the region of the frames 16 and 25 or the intermediate elements, in particular the free ends 20 thereof. Besides different, transparent combinations of the plastics that are to be connected to one another, which are formed for example of thermoplastics or thermoplastic elastomers, combinations of dark plastics using special pigments are also possible if, as mentioned above, the different absorption capability or the different absorbability is taken into account.

Besides omitting the time required to apply the adhesive in the case of a known connection operation using Uw-curable adhesive, fixing by means of a laser may take place for example within about 1 s, whereas, for curing, a curing time of for example about 20 s is needed. It is furthermore assumed that no additional use of material is necessary for laser plastic welding than when using an adhesive, and that no foreign substances or particles are released into the highly pure atmosphere used for connecting the elements of the projection device 1.

It may be mentioned that for a reliable and secure fixing of the mount R to the frame 16 or 25 a connection is not required at all the side edges of the essentially square or usually rectangular mount R, but rather that it can be also be achieved for example with three weld spots given an appropriate choice of the fixing points 21 and 21′.

It may furthermore be mentioned that the method according to the invention is not restricted to a positioning and fixing of displays 9, 10, 11 on a frame 16 or 25 of a projection device 1, but rather in a general manner elements that consist at least partially of plastic can be fixed to one another by laser plastic welding, in particular with the interconnection of the intermediate elements 18.

It may furthermore be mentioned that given an appropriate choice of plastics and for example through-holes in the region of the fixing points 21 on the mounts R, the intermediate elements 18 proposed for adjustment and bearing purposes between the elements that are to be connected may also be provided on the boundary surfaces of the respective mounts R of the displays, whereupon connection of the free ends 20 to the surfaces of the frames 16 and 25 can then be carried out.

1. A method of positioning and fixing at least one element relative to or on a frame, in particular a display (9, 10, 11), having a mount (R), of a projection device (1) on a frame (16, 25) for another optically active element (14) of the projection device (1) that is arranged on the frame, wherein the element or the mount of the display and mount parts of the frame are formed on plastic sections that are to be connected to one another, said method comprising the following steps:
positioning the element, in particular the display (9, 10, 11, R), relative to the frame (16, 25);
adjusting the element (9, 10, 11, R) relative to the frame;
connecting the element (9, 10, 11, R) to the frame (16, 25) by using laser plastic welding, in particular point laser plastic welding.

2. A method as claimed in claim 1, wherein the adjustment of the element (9, 10, 11, R) relative to the frame (16, 25) is carried out with the interconnection of in particular elastically movable intermediate elements (18) which jut out at least partially from the mutually facing edge or boundary surfaces of the element and/or frame.

3. A method as claimed in claim 2, wherein the connection by laser plastic welding between the element (9, 10, 11, R) and the frame (16, 25) is carried out in the region of the intermediate elements (18) which jut out.

4. A method as claimed in claim 1, wherein the element or the mount (R) of the display (9, 10, 11) is formed, at least in the region where it is connected to the frame (16, 25), of a transparent plastic or a plastic of lower absorption than the absorption capability of the plastic of the frame.

5. A projection device for projecting image information, comprising at least one display (9, 10, 11) which is to be positioned relative to a frame (16, 25) of another optically active element (14) of the projection device (1) and fixed to said frame, wherein at least one mount (R) of the display (9, 10, 11) and the frame (16, 25) are formed of plastic at regions that are to be connected to one another, wherein the mount (R) of the display (9, 10, 11) is fixed to the frame (16, 25) in its position relative to the frame by weld spots or a weld seam which are/is produced by laser plastic welding.

6. A projection device as claimed in claim 5, wherein in particular elastically movable intermediate elements (18) which jut out are provided on mutually facing surfaces of the mount (R) of the display (9, 10, 11) and/or the frame (16, 25), on which intermediate elements (18) the weld spots and/or weld seam are/is made in order to fix the display on the frame.

7. A projection device as claimed in claim 6, wherein the intermediate elements (18) are formed by leaf-spring-like plastic elements which are clamped at one side and jut out, which plastic elements extend essentially parallel to the edge of the boundary surface of the mount (R) and the frame (16, 25) and in each case are fixed to the mount of the display or the frame at a corner region (19).

8. A projection device as claimed in claim 6, wherein the intermediate elements (18) are oriented by their free ends in opposite directions on essentially parallel boundary surfaces of the frame (16), which frame has an essentially rectangular or square outer contour.

9. A projection device as claimed in claim 5, wherein the mount (R) of the display (9, 10, 11) is designed, in regions where it is fixed to the frame (16, 25) by laser plastic welding, with a cross section that is smaller than the cross section (21) of adjoining part-regions of the mount.

10. A projection device as claimed in claim 5, wherein the mount (R) of the display (9, 10, 11) is made, at least in the region (21) where it is connected to the frame (16, 25), of a transparent plastic or a plastic of lower absorption than the absorption capability of the plastic of the frame or intermediate elements.
